(19) United States
(12) Patent Application Publication
(10) Pub. No.: US 2007/0252427 A1
(43) Pub. Date: Nov. 1, 2007

(54) Bicycle hub

(75) Inventor: Takanori Kanehisa, Sakai (JP)

Correspondence Address: GLOBAL IP COUNSELORS, LLP, 1233 20TH STREET, NW, SUITE 700, WASHINGTON, DC, 20036-2680, US

(73) Assignee: Shimano Inc., Sakai (JP)

(21) Appl. No.: 11/708,544

(22) Filed: Feb. 21, 2007

(30) Foreign Application Priority Data
Apr. 26, 2006 (JP) JP 2006-122116

(51) Int. Cl. B60B 27/04

(52) U.S. Cl. 301/110.5

(57) ABSTRACT

A front bicycle hub is provided with a hub shaft, a hub shell and at least one shaft bearing (preferably two shaft bearings). The hub shaft has an external thread formed on the outer circumference surface at least one end and an internal thread formed on the inner circumference of the end where the external thread is formed. The hub shell is rotatably supported on the outer circumference side of the hub shaft by the shaft bearing. The shaft bearing is threaded on with external thread of the hub shaft. The internal thread is formed deeper toward the inner side in the axial direction than the shaft bearing.

### BACKGROUND OF THE INVENTION

1. Field of the Invention

This invention generally relates to a bicycle hub. More specifically, the present invention relates a bicycle hub that can be secured to a bicycle frame.

2. Background Information

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle. One component that has been extensively redesigned is the bicycle hub.

A bicycle hub basically has a hub shaft, a hub shell disposed on the outer circumference side of the hub shaft, and a pair of shaft bearings rotatably supporting the hub shell on the hub shaft. In a conventional hub, an external thread is formed on the outer circumference surface of both tips of the hub shaft for receiving a fixing nut at each end to secure the bicycle hub at the tips of the front fork of the frame or a chain stay (see, for example, German Utility Model No. 29702091 and Unexamined Japanese Patent Application Publication No. 2004-75014). In such a conventional bicycle hub, the inner rings of the bearings are screwed on the hub shaft towards. By tightening the bearings towards each other, the amount of ply in the bearing is reduced to maintain the rotational performance of the bearings. Lock nuts are installed on the outer ends of the hub shaft to prevent rotation (unthreading) of the inner rings by the lock nut.

If the hub shaft is secured to the bicycle frame using a fixing nut as in the above mentioned conventional hubs, then the axial length of the thread of the fixing nut cannot be too long. Thus, this arrangement limits the amount of force that can be obtained to maintain a secured connection. In particular, in the case of a bicycle for competition used in motocross competitions or half-pipe competitions in which frequent jumping is involved, the hub shaft and/or nut member may not withstand the impact when landing.

Use of a fixing bolt to secure the hub shaft instead of the nut member has been considered. By using a fixing bolt, the restriction on thread length is less than that on the nut member, and thus, easily improving the securing force. However, if the fixing bolt is used to secure the hub to the frame, then a substantial load may be applied to the internal surface (threaded) of the hub shaft by the fixing bolt. Specifically, this is because substantial tension is applied to the internal thread at the tip of the fixing bolt, and tension is also applied to the external thread in the area where the ball bearing is screwed to the hub shaft when the lock nut and the inner ring of the shaft bearing rotate in opposite directions. If the area to which these two tensions are applied is located close together along the hub shaft, then a substantial load may be applied.

In view of the above, it will be apparent to those skilled in the art from this disclosure that there exists a need for an improved bicycle hub. This invention addresses this need in the art as well as other needs, which will become apparent to those skilled in the art from this disclosure.

### SUMMARY OF THE INVENTION

One object of the present invention is to provide a bicycle hub does not apply a substantial load on the hub shaft if the hub shaft is secured to a bicycle frame with a fixing bolt.

In accordance with a first aspect of the present invention, a bicycle hub is provided that basically comprises a hub shaft, a hub shell and a first shaft bearing. The hub shaft includes an outer circumference surface with an external thread disposed at least on a first axial end portion of the hub shaft and an internal bore having an inner circumference surface with an internal thread disposed at the first axial end portion of the hub shaft where the external thread is formed. The hub shell is disposed around the outer circumference of the hub shaft to rotation in at least one rotational direction relative to the hub shaft. The first shaft bearing is threaded on the external thread of the hub shaft to rotatably support the hub shell on the hub shaft at a first bearing support location. The internal thread of the hub shaft extends farther inwardly along the hub shaft in an axial direction toward a middle portion of the hub shaft than the first bearing support location of the shaft bearing.

In this bicycle hub, when the hub is secured to the bicycle frame by screwing the fixing bolt into the internal thread, it is possible to position the tip of the screwed section deeper toward the inner side in the axial direction than the attachment section of the shaft bearing. Consequently, the area to which the two tensions are applied can be spaced apart in the axial direction of the hub shaft. Here, an internal thread is formed deeper toward the inner side in the axial direction than a shaft bearing, allowing the tip of the fixing bolt to be positioned deeper toward the inner side in the axial direction than the shaft bearing. As a result, if the hub shaft is secured with a fixing bolt, a substantial load is prevented from being applied to the hub shaft.

According to a second aspect of the present invention, the bicycle hub of the present invention is further provided such that the internal thread of the hub shaft extends farther along the hub shaft toward the middle portion of the hub shaft than the external thread of the hub shaft. In this case, because the axial length of the external thread is shorter than the internal thread, the tip of the fixing bolt is ensured to be positioned deeper toward the inner side in the axial direction than the shaft bearing. Additionally, because the internal thread length is longer, it is possible to make the screw length of the fixing bolt longer, thus further strengthening the force when secured.

According to a third aspect of the present invention, the bicycle hub of the present invention is further provided such that the external thread of the hub shaft extends farther along the hub shaft toward the middle portion of the hub shaft than the first bearing support location of the first shaft bearing. In this case, the external thread is formed farther toward the inner side in the axial direction than the shaft bearing, thereby increasing the freedom level of the shaft bearing with regard to the arrangement position.

According to a fourth aspect of the present invention, the bicycle hub of the present invention is further provided such that the first shaft bearing includes an inner ring, an outer ring and a roller members between the inner and outer rings with the inner ring being threaded on the external thread of the hub shaft. In this case, the force on the roller members of the shaft bearing can be easily adjusted depending on how far the inner ring of the shaft bearing is screwed onto the hub shaft.

According to a fifth aspect of the present invention, the bicycle hub of the present invention is further provided with a threaded fastener that is threadedly engaged with the internal thread of the hub shaft. In this case, because a fixing bolt is also provided in the hub, it is possible to set the length of the internal thread to the optimal state to decrease weight while maintaining force.

According to a sixth aspect of the present invention, the bicycle hub of the present invention is further provided such that the threaded fastener includes a bolt member, a washer and a retaining member, with the washer being rotatably attached to the bolt member by the retaining member. In this case, because the washer member is coupled to the bolt member with a retaining member, the washer member can be coupled to the bolt member by simply attaching the retaining member to the bolt member or the washer member. Therefore, even if a washer member is used, it is possible to avoid forgetting to attach the washer member, and it is also possible to easily couple the washer member to the bolt member.

According to a seventh aspect of the present invention, the bicycle hub of the present invention is further provided such that the internal thread of the hub shaft is formed so that a tip of the bolt member is positioned farther along the hub shaft toward the middle portion of the hub shaft than the first bearing support location of the first shaft bearing. In this case, it is possible to ensure shifting of the position to locate the tip of the fixing bolt to which strong tension is applied in the internal thread away from the shaft bearing.

According to an eighth aspect of the present invention, the bicycle hub of the present invention is further provided with a freewheel disposed around the hub shaft and operatively coupled to the hub shell to transmit only one directional rotation to the hub shell. In this case, a rear bicycle hub is provided where it is possible to prevent an excessive load from being applied to the hub shaft even if the hub shaft is secured with a fixing bolt.

According to the present invention, the internal thread is formed deeper toward the inner side in the axial direction than the shaft bearing, allowing the tip of a fixing bolt to be positioned toward the inner side in the axial direction than the shaft bearing. Therefore, if the hub shaft is secured with a fixing bolt, a substantial load is prevented from being applied to the hub shaft.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a side elevational view of a bicycle that is equipped with a pair of bicycle hubs in accordance with a first embodiment of the present invention;

FIG. 2 is a partial cross sectional view of the front bicycle hub in accordance with the first embodiment of the present invention;

FIG. 3 is a partial cross sectional view of the fixing bolt used in the front bicycle hub in accordance with the first embodiment of the present invention;

FIG. 4 is an exploded perspective view of the fixing bolt used in the front bicycle hub in accordance with the first embodiment of the present invention;

FIG. 5 is a partial cross sectional view of the rear bicycle hub in accordance with the first embodiment of the present invention;

FIG. 6 is a partial cross sectional view, equivalent to FIG. 2, of a front bicycle hub in accordance with another embodiment of the present invention;

FIG. 7 is a partial cross sectional view, equivalent to FIG. 5, of a rear bicycle hub in accordance with another embodiment of the present invention; and

FIG. 8 is a partial cross sectional view, equivalent to FIG. 5, of a rear bicycle hub of still another embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

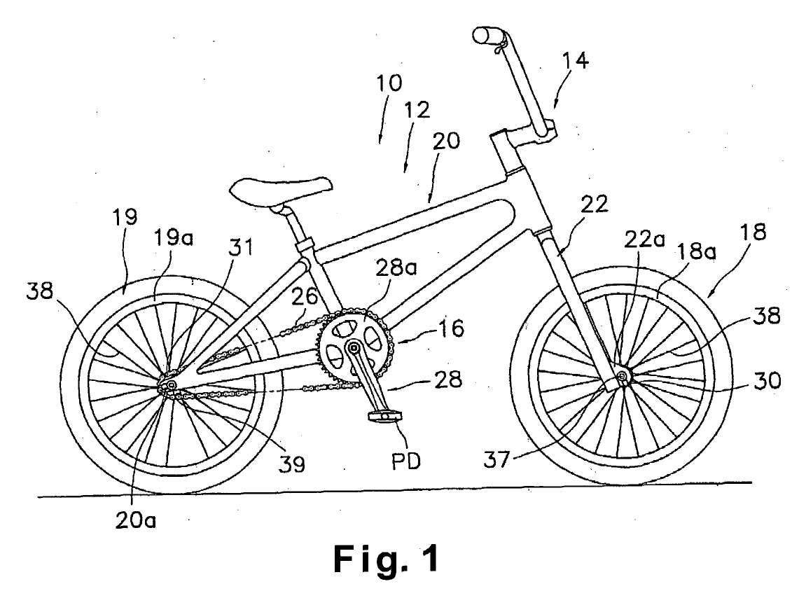

Referring initially to FIG. 1, a bicycle 10 is illustrated that is equipped in accordance with a first embodiment of the present invention. The bicycle 10 has wheels with small diameters such as the ones used on BMX bicycles for motocross or half-pipe competitions. The bicycle 10 basically includes a frame 12, a handlebar 14 a drive train 16, a front wheel 18, and a rear wheel 19. The frame 12 includes a frame body 20 and a front fork 22 attached the frame body 20. Preferably, the front fork 22 is rotatably attached to the front part of the frame body 20 to rotate around a diagonally oriented vertical axis. The handlebar 14 is secured to the front fork 22 for steering the front wheel 18 that is attached at the front end (front claws 22a) of the front fork 22 via a front bicycle hub 30. The rear wheel 19 is attached to a rear end of the frame body 20. The drive train 16 basically includes a chain 26, a gear crank 28 with a pair of pedals PD (only one seen in FIG. 1) and a front sprocket 28a, and a rear bicycle hub 31 that is part of the rear wheel 19. In particular, the rear end of the frame body 20 has a pair of rear claws 20a forming slits that receive the rear bicycle hub 31. Thus, the rear wheel 19 is attached to the rear claws 20a by the rear bicycle hub 31. In FIG. 1, the illustration of the brake devices are omitted, but preferably a cantilever brake, for example, is attached to the frame 12 for applying a braking force to the front wheel 18 and the rear wheel 19.

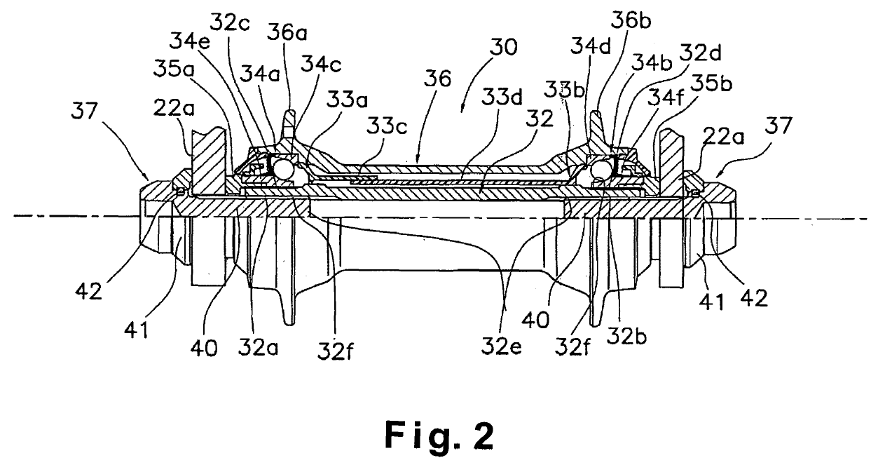

As illustrated in FIG. 2, the front bicycle hub 30 basically includes a hub shaft 32, a pair of shaft bearings 32a and 32b and an approximately cylindrical hub shell 36. The hub shaft 32 has first and second axial end portions that are fixedly secured to the front claws 22a of the front fork 22. In particular, the hub shaft 32 is removably secured to the front claws 22a of the front fork 22 by a pair of threaded fasteners or fixing bolts 37. The hub shell 36 is rotatably disposed around the outer circumference of the hub shaft 32 by the shaft bearings 32a and 32b such that the front wheel 18 can rotate relative to the front fork 22 about a front hub axis. In particular, the shaft bearings 32a and 32b are situated between the hub shaft 32 and the hub shell 36 with the shaft bearings 32a and 32b being screwed onto the first and second axial end portions of the hub shaft 32.

The hub shaft 32 is preferably a hollow shaft member with an internal bore extending completely therethrough. The hub shaft 32 also has an inner circumference surface with a first internal thread 32a located at the first axial end portion and a second internal thread 32b located at the second axial end portion. The hub shaft 32 also has an outer circumference surface with a first external thread 32c located at the first axial end portion and a second external thread 32d located at the second axial end portion. While preferably both axial end portions are internally threaded and externally threaded, it will be apparent to those skilled in the art from this disclosure that only one of the axial end portions can be both internally threaded and externally threaded, if needed and/or desired. The internal threads 32a and 32b are formed at the first and second axial end portions so that the overlap with the external threads 32c and 32d, respectively. Furthermore, the shaft directional length of each of the internal threads 32a and 32b is longer than the shaft directional length of each of the external threads 32c and 32d. In other words, the internal thread 32a of the hub shaft 32 extends farther along the hub shaft 32 toward a middle portion of the hub shaft 32 than the external thread 32c of the hub shaft 32, and the internal thread 32b of the hub shaft 32 extends farther along the hub shaft 32 toward the middle portion of the hub shaft 32 than the external thread 32d of the hub shaft 32. Moreover, the tips of the internal threads 32a and 32b are positioned along the hub shaft 32 in an axial direction toward the middle portion of the hub shaft 32 than first and second bearing support locations of the shaft bearings 34a and 34b, respectively.

In this arrangement, where both inner and outer circumference surfaces are threaded, significant tension tends to be applied to the tip areas where the bolts 37 and the shaft bearings 34a and 34b are screwed onto the first and second axial end portions of the hub shaft 32. In the illustrated configuration, it is preferable that the tip areas are not aligned such that a substantial load is not applied to the hub shaft 32 at the same axial location along the hub shaft 32. Specifically, when the fixing bolts 37 are screwed into the internal threads 32a and 32b of the hub shaft 32 and tightened down, substantial tension is applied to the hub shaft 32 at each bolt tip area 32e of each of the internal threads 32a and 32b of the hub shaft 32 where the free ends of the fixing bolts 37 are located. Also when the shaft bearings 34a and 34b are screwed onto the external threads 32c and 32d of the hub shaft 32 and tightened down, substantial tension is applied to the hub shaft 32 at each innermost bearing side area 32f of each of the internal threads 32a and 32b of the hub shaft 32 where the innermost side portion of the shaft bearings 34a and 34b are located. In addition, during riding the bicycle 10, a significant load is applied to the fixing bolts 37 by the front fork 22. This load on the fixing bolts 37 is transmitted to the hub shaft 32. By attaching the fixing bolts 37 deeper toward the middle portion of the hub shaft 32 than the bearing support locations of the shaft bearings 34a and 34b, a substantial load can be effectively prevented from being applied to the hub shaft 32 at the shaft bearings 34a and 34b.

The shaft bearings 34a and 34b are preferably adjustable cone type ball bearings. The shaft bearing 34a has an outer ring or cup 34c securely pressed in an inner circumference surface of a first end in the hub shell 36, while the bearing 34b has an outer ring or cup 34d securely pressed in an inner circumference surface of a second end in the hub shell 36. The shaft bearing 34a also has an inner ring or cone 34e securely threaded onto the external thread 32c of the hub shaft 32, while the bearing 34b also has inner ring or cone 34f securely threaded onto the external thread 32d of the hub shaft 32. The shaft bearing 34a also has a plurality of roller members or balls disposed between the outer ring or cup 34c and the inner ring or cone 34e, while the shaft bearing 34b has a plurality of roller members or balls disposed between the outer ring or cup 34d and the inner ring or cone 34f. By adjusting the amount that the inner ring or cones 34e and 34f are threaded onto the external threads 32c and 32d, the load or force applied to the roller members or balls can be adjusted to control the play in the shaft bearings 34a and 34b. The shaft bearings 34a and 34b are filled with grease with a pair of grease dispersion preventive members 33a and 33b being attached inwardly of the ball shaft bearings 34a and 34b so as to maintain the grease in the shaft bearings 34a and 34b. In particular, the grease dispersion preventive member 33a is attached to the inner circumference surface of the hub shell 36 so as to come in contact with the outer ring 34c of the ball shaft bearing 34a, where it is situated in opposition to a small gap left on the outer circumference surface of the hub shaft 32. Similarly, the grease dispersion preventive member 33a is attached to the inner circumference surface of the hub shell 36 so as to come in contact with the outer ring 34d of the ball shaft bearing 34b, where it is situated in opposition to a small gap left on the outer circumference surface of the hub shaft 32. Furthermore, both of the grease dispersion preventive members 33a and 33b have cylindrical sections 33c and 33d with outer diameters formed such that they overlap each other on the inner and outer circumference surfaces.

Lock nuts 35a and 35b are attached outside the shaft direction of the ball shaft bearings 34a and 34b. The lock nuts 35a and 35b contact with the inner rings 34e and 34f of the ball shaft bearings 34a and 34b to prevent the inner rings 34e and 34f of the ball shaft bearings 34a and 34b from unthreading. In particular, the lock nuts 35a and 35b are screwed onto the external thread 32c and 32d of the hub shaft 32, respectively, thereby preventing rotation of the inner rings 34e and 34f.

The diameter of the hub shell 36 is small at the center in the axial direction and becomes larger at both ends where a pair of hub flanges 36a and 36b is formed at the outer circumference surface of the large diameter sections. The hub flanges 36a and 36b are coupled to a rim 18a of the front wheel 18 via a plurality of spokes 38, as illustrated in FIG. 1.

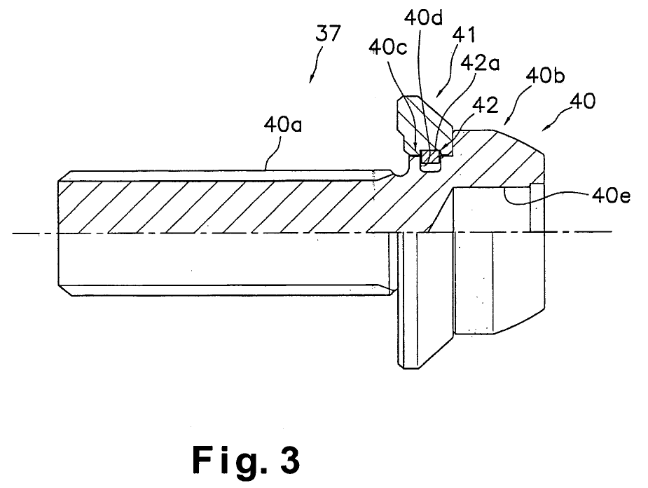

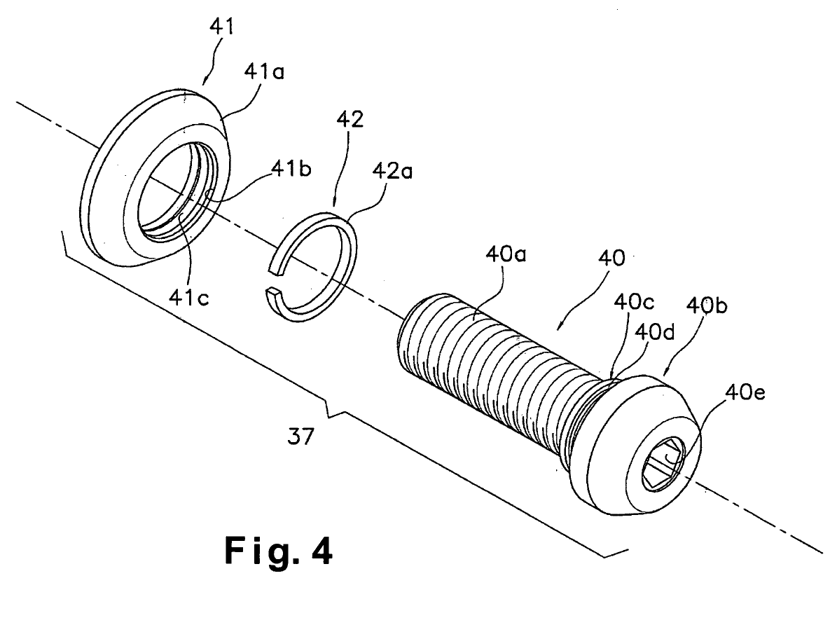

As seen in FIGS. 3 and 4, each of the fixing bolts 37 includes a bolt member 40, a washer member 41 and a retaining member 42. The bolt member 40 is screws into the internal thread 32a and 32b formed at both ends of the hub shaft 32 for securing the front bicycle hub 30 to the front fork 22. The washer member 41 is rotatably attached to the bolt member 40 and able to contact the outside surface of the front claws 22a. The retaining member 42 retains the washer member 41 to the bolt member 40. Preferably, retaining member 42 is in the form of a C-type retaining ring 42a.

The bolt member 40 is in the form of a hexagonal socket head bolt. The bolt member 40 has a shaft portion with an external thread 40a, a head portion 40b, a washer attachment section 40c and a first annular groove 40d. The external thread 40a is configured to be screwed together with internal thread 32a or 32b. The head section 40b has a large diameter provided at one end of the external thread 40a. The external thread 40a is preferably an M10 screw or the like, and the shaft directional length thereof is approximately 25-30 mm. The outer circumference of the head section 40b is gradually decreased in diameter size toward the end. At the end surface of the head section 40b, a hexagonal tool engagement section 40e is formed to engage an Allen wrench.

The washer member 41 is rotatably attached to the bolt member 40 at the washer attachment section 40c by the retaining member 42. The washer member 41 is able to contact the outside surface of the front claws 22a. The washer attachment section 40c is provided between the head section 40b and the external thread 40a. The washer attachment section 40c is smaller in diameter than the head section 40b, but has a larger outer diameter than the inner diameter of the C retaining ring 42a in a free state. In the washer attachment section 40c, the first annular groove 40d is formed to engage the retaining member 42. The first annular groove 40d is formed slightly deeper than the thickness of the retaining member 42. This enables the retaining member 42 to be decreased in diameter compared to the outer diameter of the washer attachment section 40c when the washer member 41 is attached, thereby allowing smooth attachment of the washer member 41,

The washer member 41 is a ring-shaped member that is thicker than the shaft directional length of the washer attachment section 40c. The washer member 41 is situated between the head section 40b and the front claws 22a when the front bicycle hub 30 is attached to the front fork 22. The outer circumference of the washer member 41 comprises a first tapered section 41a that gradually decreases in diameter towards the head section 40b. Furthermore, the inner circumference comprises a second tapered section 41b that gradually increases in diameter towards the head section 40b. At a position opposite the first annular groove 40d in the inner circumference surface of the washer member 41, a second annular groove 411c is formed to engage the outer circumference of the retaining member 42. The bottom diameter of the second annular groove 41c is the same as, or slightly smaller than, the outer circumference of the retaining member 42 in a free state.

The procedure to couple the washer member 41 to the fixing bolt will now be explained. First, the C-type retaining ring 42a, which is the retaining member 42, is attached to the first annular groove 40d in the washer attachment section 40c of the bolt member 40. After the C-type retaining ring 42a is attached, the washer member 41 is attached to the washer attachment section 40c with a decreasing diameter. At this time, the second tapered section 41b comes in contact with the outer circumference surface of the C-type retaining ring 42a, and the C-type retaining ring 42a can be gradually decreased in diameter. In addition, the washer member 41 is inserted deep inside the washer attachment section 40c, thereby opposing the second annular groove 41c to the first annular groove 40d. The decreased C-type retaining ring 42a in the diameter then becomes larger in diameter due to elasticity and is latched to the second annular groove 41c as well as the both circle grooves 40d and 41c. As a result, the washer member 71 is rotatably coupled to the bolt member 40 to be retained.

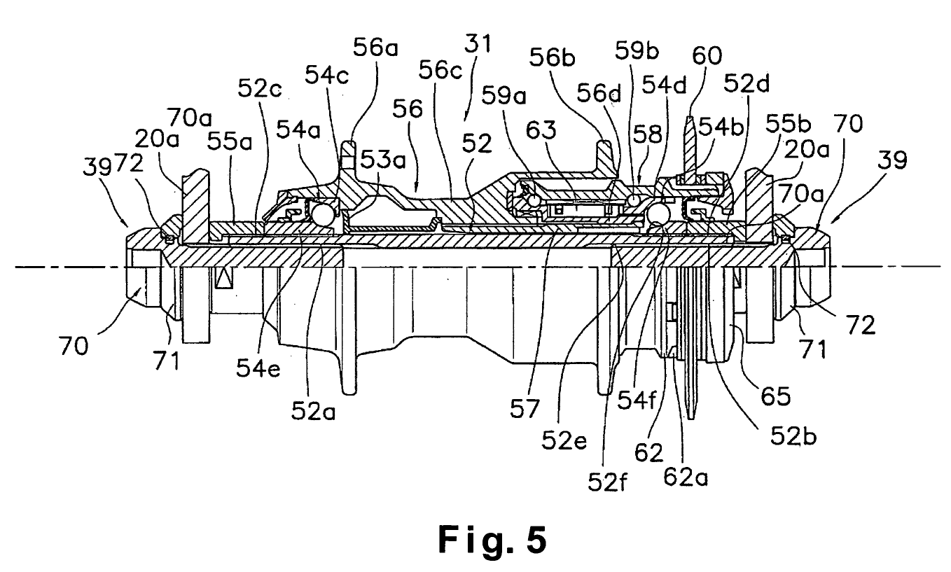

As illustrated in FIG. 5, the rear bicycle hub 31 basically includes a hub shaft 52, a pair of shaft bearings 52a and 52b, an approximately cylindrical hub shell 56 and a freewheel 58 with a rear sprocket 60. The hub shaft 52 has first and second axial end portions that are fixedly secured to in the rear claws 20a. In particular, the hub shaft 52 is removably secured to the rear claws 20a by a pair of threaded fasteners or fixing bolts 39. The hub shell 56 is rotatably disposed around the outer circumference of the hub shaft 52 by the shaft bearings 52a and 52b such that the rear wheel 19 can rotate relative to the frame about a rear hub axis. The shaft bearings 52a and 52b are screwed onto the first and second axial end portions of the hub shaft 52 as described later. The freewheel 58 is situated on the right side of the hub shell 52 in FIG. 5 and is rotatably attached to the hub shell 52 as a unit.

The hub shaft 52 is preferably a hollow shaft member with an internal bore extending completely therethrough. The hub shaft 52 also has an inner circumference surface with a first internal thread 52a located at the first axial end portion and a second internal thread 52b located at the second axial end portion. The hub shaft 52 also has an outer circumference surface with a first external thread 52c located at the first axial end portion and a second external thread 52d located at the second axial end portion. While preferably both axial end portions are internally threaded and externally threaded, it will be apparent to those skilled in the art from this disclosure that only one of the axial end portions can be both internally threaded and externally threaded, if needed and/or desired. The internal threads 52a and 52b are formed at the first and second axial end portions so that the overlap with the external threads 52c and 52d, respectively. Furthermore, the shaft directional length of each of the internal thread 52a and 52b is longer than the shaft directional length of each of the external thread 52c and 52d. In other words, the internal thread 52a of the hub shaft 52 extends farther along the hub shaft 52 toward a middle portion of the hub shaft 52 than the external thread 52c of the hub shaft 52, and the internal thread 52b of the hub shaft 52 extends farther along the hub shaft 52 toward the middle portion of the hub shaft 52 than the external thread 52d of the hub shaft 52. Moreover, the tips of the internal threads 52a and 52b are positioned along the hub shaft 52 in an axial direction toward the middle portion of the hub shaft 52 than first and second bearing support locations of the shaft bearings 54a and 54b, respectively. This is done for the same reason as the front bicycle hub 30, i.e., to avoid load concentration at tip areas 52e and 52f of each of the internal threads 52a and 52b of the hub shaft 52 where the free ends of the fixing bolts 39 are located. In other words, when the shaft bearings 54a and 54b are screwed onto the external threads 52c and 52d of the hub shaft 52 and tightened down, substantial tension is applied to the hub shaft 52 at each innermost bearing side area 52f of each of the internal threads 52a and 52b of the hub shaft 52 where the innermost side portion of the shaft bearings 54a and 54b are located. In addition, during riding the bicycle 10, a significant load is applied to the fixing bolts 39 by the frame. This load on the fixing bolts 39 is transmitted to the hub shaft 52. By attaching the fixing bolts 39 deeper toward the middle portion of the hub shaft 52 than the bearing support locations of the shaft bearings 54a and 54b, a substantial load can be effectively prevented from being applied to the hub shaft 52 at the shaft bearings 54a and 54b.

The shaft bearings 54a and 54b are preferably cone type ball bearings. The shaft bearing 54a has an outer ring or cup 54c securely pressed in an inner circumference surface of a first end (i.e., the hub main section 56c) in the hub shell 56, while the bearing 54b has an outer ring or cup 54d securely screw onto an outer circumference surface of a motive energy carrier 56d that is disposed in a second end in the hub shell 56. The shaft bearing 54a also has an inner ring or cone 54e securely threaded onto the external thread 52c of the hub shaft 52, while the bearing 54b also has inner ring or cone 54f securely threaded onto the external thread 52d of the hub shaft 52. The shaft bearing 54a also has a plurality of roller members or balls disposed between the outer ring or cup 54c and the inner ring or cone 54e, while the shaft bearing 54b has a plurality of roller members or balls disposed between the outer ring or cup 54d and the inner ring or cone 54f. By adjusting the amount that the inner ring or cones 54e and 54f are threaded onto the external threads 52c and 52d, the load or force applied to the roller members or balls can be adjusted to control the play in the shaft bearings 54a and 54b. The shaft bearings 54a and 54b are filled with grease with a pair of grease dispersion preventive members 53a and 53b being attached inwardly of the ball shaft bearings 54a and 54b so as to maintain the grease in the shaft bearings 54a and 54b.

Lock nuts 55a and 55b are attached outside the shaft direction of the ball shaft bearings 54a and 54b. The lock nuts 55a and 55b contact with the inner rings 54e and 54f of the ball shaft bearings 54a and 54b to prevent the inner rings 54e and 54f of the ball shaft bearings 54a and 54b from unthreading. In particular, the lock nuts 55a and 55b are screwed onto the external thread 52c and 52d of the hub shaft 52, respectively, thereby preventing rotation of the inner rings 54e and 54f.

The diameter of the hub shell 56 is small at the center in the axial direction and becomes larger at both ends where a pair of hub flanges 56a and 56b is formed at the outer circumference surface of the large diameter sections. The hub flanges 56a and 56b are coupled to a rim 19a of the front wheel 19 via a plurality of the spokes 38, as illustrated in FIG. 1. The hub shell 56 also includes a hub main section 56c and a motive energy carrier 56d that is non-rotatably coupled to the motive energy carrier 56d. The hub main section 56c is an approximately cylindrical member with the hub flanges 50a and 50b being formed on the outer circumference surface.

The freewheel 58 transmits only unidirectional rotation (traveling direction) to the hub shell 56. The freewheel 58 basically includes a power driver 62 rotatably supported on the outer circumference of the motive energy carrier 56d, and a unidirectional clutch 63 situated between the power driver 62 and the motive energy carrier 56d.

The motive energy carrier 56d is a stepped cylindrical steel member, with an inner circumference surface of one end thereof (leftmost part in FIG. 5) being non-rotatably attached to one end of the hub main section 56c (rightmost part in FIG. 5) by a serration combination, for example. The motive energy carrier 56d is secured to the hub main section 56c by a cylindrical bolt 57 that is screwed into the inner circumference surface of the hub main section 56c by passing through the inner circumference surface of the hub main section 56c. The outer ring 54d of the ball shaft bearing 54b is screwed into and attached to the outer circumference surface of the other end of the motive energy carrier 56d (rightmost part in FIG. 5). Also, the unidirectional clutch 63 is attached deep inside (leftmost part in FIG. 5) the attachment section of the ball shaft bearing 54b. Furthermore, the freewheel 58 is supported by a pair of freewheel bearings 59a and 59b. The freewheel bearings 59a and 59b are situated on both sides of the unidirectional clutch 63 so as to rotatably support the freewheel 58.

The power driver 62 of the freewheel 58 has a sprocket attachment section 62a for attaching the rear sprocket 60 on the outer circumference. The power driver 62 is rotatably supported on the outer circumference of the motive energy carrier 56d, with the unidirectional clutch 63 being situated between the power driver 62 and the motive energy carrier 56d to transmit only the traveling direction rotation to the motive energy carrier 56d. The power driver 62 is rotatably supported to the motive energy carrier 56d by the freewheel bearings 59a and 59b. The rear sprocket 60 is attached to the sprocket attachment section 62a preferably by a spline connection (i.e., a plurality of axially extending splines) to enable rotation as a unit. The rear sprocket 60 is retained on the sprocket attachment section 62a by an installing bolt 65 that is screwed into an inner circumference surface of the power driver 62. The unidirectional clutch 63 is preferably a claw type that is movably attached to the motive energy carrier 56d to transmit only the traveling direction rotation of the power driver 62 to the motive energy carrier 56d.

The fixing bolts 39 are identical to the fixing bolts 37 for the front bicycle hub 30, except for the axial lengths of the fixing bolts 39 are longer than the axial lengths of the fixing bolts 37. Thus, each of the fixing bolts 39 includes a bolt member 70, a washer member 71 and a retaining member 72, with the only difference compared to the fixing bolts 37 in terms of configuration is that an external thread 70a of the bolt member 70 is longer than the external thread 40a of the bolt member 40. The axial lengths of the external threads 70a are preferably 30-35 mm. This is because the rear bicycle hub 31 is applied to a larger load than the front bicycle hub 30. Thus, when the bolt members 40 and 70 are used in a fixed configuration, the fixing bolts 37 and 39 have optimal force due to an axial thread length of the external threads 40a and 70a in the bolt members 40 and 70.

To secure the front bicycle hub 30 and the rear bicycle hub 31 configured in this way to the rear of the front fork 22 and the frame body 20, respectively, the following procedure is performed to secure them.

In attaching the front bicycle hub 30 to the front fork 22, both ends of the hub shaft 32 are situated in the slits of the front claw 22a with the fixing bolts 37 slightly screwed into the internal threads 32a and 32b in the hub shaft 32 in the slits the front bicycle hub 30 is secured to the front fork 22 using an Allen wrench, which is inserted into the tool engagement sections 40e to rotate the fixing bolts 37 and tightened the fixing bolts 37 at both ends of the hub shaft 32 to the desired torque.

The procedure for attaching the rear bicycle hub 31 is the same. Both ends of the hub shaft 52 are situated in the slits of the rear claws 20a with the fixing bolt 39 slightly screwed into the internal threads 52a and 52b in the hub shaft 52. In this state, the rear bicycle hub 31 is secured to the rear of the frame body 20 when the fixing bolts 39 are tightened at both ends of the hub shaft 52 to the desired torque using the Allen wrench.

The washer members 41 and 71 are attached to the bolt members 40 and 70 so as to make it easier and faster to install the hubs 30 and 31. Furthermore, because the washer members 41 and 71 are coupled to the bolt members 40 and 70 with the retaining members 42 and 72, the washer members 41 and 71 can be coupled to the bolt members 40 and 70 by simply attaching the retaining members 42 and 72 to the bolt members 40 and 70 or the washer members 41 and 71. Thus, coupling the washer members 41 and 71 to the bolt members 40 and 70 can be easily accomplished.

### Other Embodiments

In the previous embodiment, the washer member 41 is coupled to the bolt member 40 by the retaining member 42. However, the retaining member can be attached to the washer member 41 in advance. In this case, the depth of the second annular groove 41c needs to be larger than the diameter direction of the retaining member 42. Furthermore, it is preferable to make the bottom diameter of the first annular groove 40d the same as, or slightly larger than, the inner diameter of the retaining member 42.

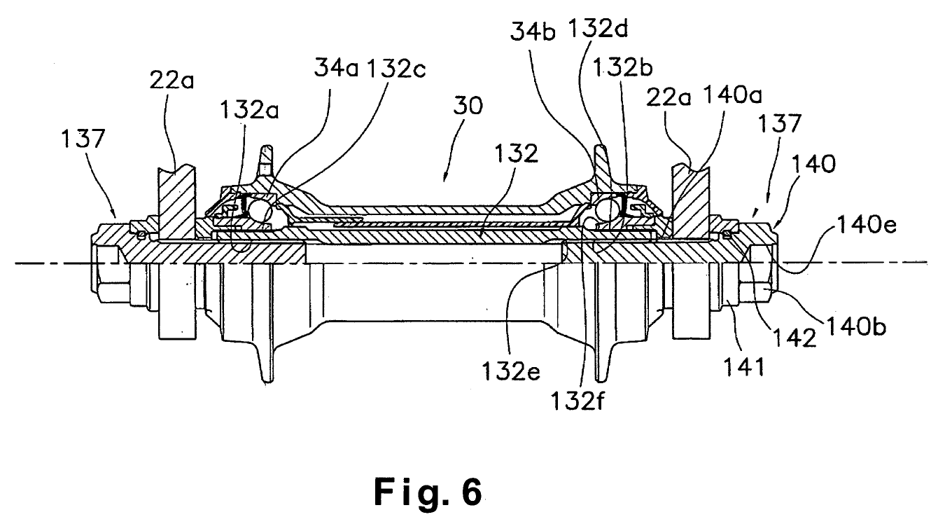

The configurations of the fixing bolts (threaded fasteners) are also not restricted to that of the previously discussed embodiment. The fixing bolts can be a bolt with an ordinary washer wherein the washer is not retained on the bolt member. In FIGS. 6 to 8, different fixing bolts are illustrated, i.e., a pair of modified fixing bolts 137 for the front hub 30 and a pair of modified fixing bolts 139 for the rear hub 31. Each of the fixing bolts 137 basically includes a bolt member 140, a washer members 141 and retaining member 142. Similarly, each of the fixing bolts 139 basically includes a bolt member 170, a washer member 171, and a retaining member 172. Among these parts, the form of the bolt members 140 and 170 and the washer members 141 and 171 are different from that of the previous embodiment.

Each of the bolt members 140 has an external thread 140a and a head section 140b. The head section 140b is in the form of a hexagonal bolt with a hexagonal tool engagement surface on an outer circumference surface to engage a tool such as a spanner. Moreover, head section 140b has a tool engagement section 140e for the Allen wrench. The external thread 140a of the bolt member 140 is an M9 screw thread. The screw threads of the internal threads 132a and 132b in the hub shaft 132 of the front bicycle hub 30, illustrated in FIG. 6, are M9 screw threads.

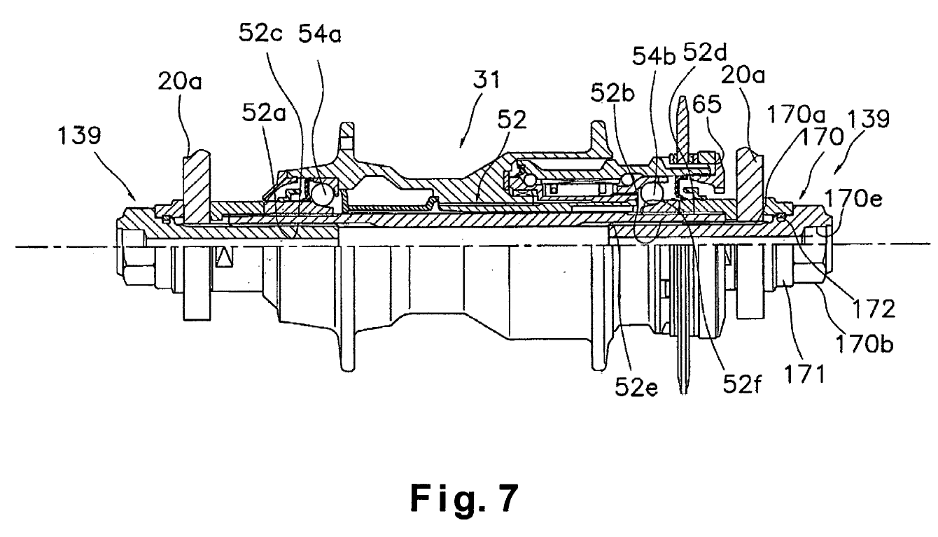

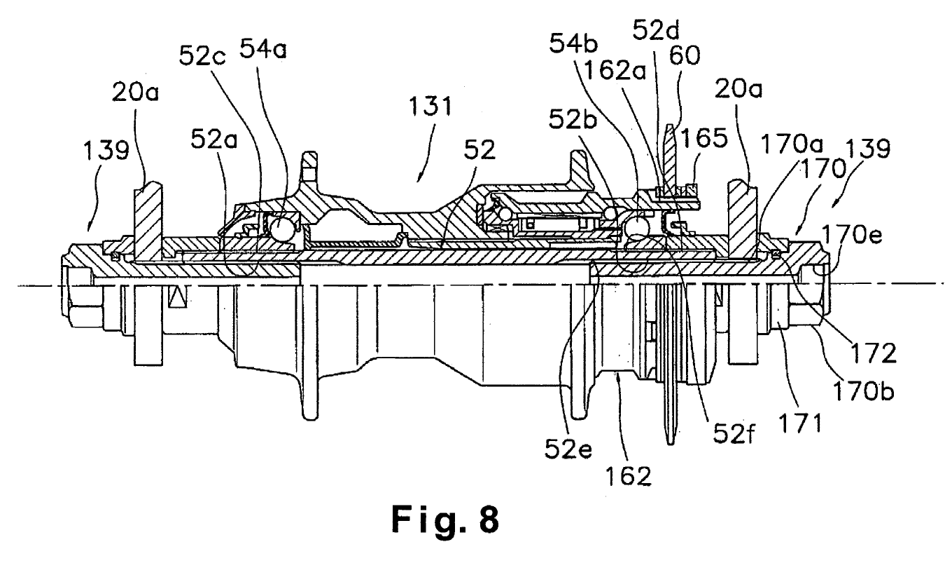

Each of the bolt members 170 has an external thread 170a and a head section 170b. The head section 170b is in the form of a hexagonal bolt with a hexagonal tool engagement surface on an outer circumference surface to engage a tool such as a spanner. Moreover, head section 170b has a tool engagement section 170e for the Allen wrench. The external thread 170a of the bolt member 170 is an M10 screw thread. Here, the force of the fixing bolts 139 for the rear bicycle hubs 31 and 131 is improved compared to the front bicycle hub 30 by the outer diameter of the external thread 170a. Consequently, the screw threads in the internal thread 52a and 52b of the hub shaft 52 in the rear bicycle hubs 31 and 131, illustrated in FIGS. 7 and 8, are M10 screw threads.

The washer members 141 and 171 have longer axial lengths than that of the previous embodiment as well as smaller outer diameters. The outer circumference surfaces of the washer members 141 and 171 are provided with a large cylindrical portion and a small cylindrical portion. The configuration of the other parts of the fixing bolts 137 and 139, including the retaining members 142 and 172, are the same as that of the previous embodiment, so the explanation thereof will be omitted.

Furthermore, as in the previous embodiment, the axial lengths of each internal threads 132a, 132b, 52a, 52b are longer than that of the corresponding one of the external threads 132c, 132d, 52c, 52d, respectively. Furthermore, the tip of each internal thread 132a, 132b, 52a, 52b (end of the inner side of the axial direction) is positioned deeper toward the inner side of the axial direction than each shaft bearing 34a, 34b, 54a, 54b, respectively.

In addition, as in the previous embodiment, at the tip areas 132e and 52e where the fixing bolts 137 and 139 of the internal threads 132a, 132b, 52a, 52b are screwed together and the attachment sections of the shaft bearings 34a, 34b, 54a, 54b, the hub shaft, and most inner parts 132f and 52f in the axial direction of the hub shafts 132 and 52 are shifted to the axial direction.

In the rear bicycle hub 131, illustrated in FIG. 8, the rear sprocket 60 is attached to the sprocket attachment section 162a preferably by a spline connection (i.e., a plurality of axially extending splines) so as to rotate as a unit. The rear sprocket 60 is secured to the sprocket attachment section 162a by an installing nut 165 screwed together with the outer circumference surface of the power driver 162.

In the previous embodiment, the front bicycle hub or the rear bicycle hub of a BMX bicycle is used as an example to explain the present invention, but the present invention is not restricted to a BMX bicycle and can be applied to all bicycle hub assemblies. In the previous embodiment, the axial lengths of the external and internal threads are different, but it can essentially be the same for the external and internal thread. In this case, needless to say, it is preferable to shift the position of the tip of the fixing bolt and the attachment section of the shaft bearing. Also in the previous embodiment, the hub is illustrated as being secured by a fixing bolt to the frame. The present invention is not restricted to this, so if the hub shaft is hollow, a quick release mechanism can be applied if necessary.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a bicycle equipped with the present invention. Accordingly, these terms, as utilized to describe the present invention should be interpreted relative to a bicycle equipped with the present invention as used in the normal riding position. Finally, terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A bicycle hub comprising:
a hub shaft including an outer circumference surface with an external thread disposed at least on a first axial end portion of the hub shaft and an internal bore having an inner circumference surface with an internal thread disposed at the first axial end portion of the hub shaft where the external thread is formed;
a hub shell disposed around the outer circumference of the hub shaft to rotation in at least one rotational direction relative to the hub shaft; and
a first shaft bearing threaded on the external thread of the hub shaft to rotatably support the hub shell on the hub shaft at a first bearing support location, the internal thread of the hub shaft extending farther inwardly along the hub shaft in an axial direction toward a middle portion of the hub shaft than the first bearing support location of the first shaft bearing.

2. The bicycle hub according to claim 1, wherein
the internal thread of the hub shaft extends farther along the hub shaft toward the middle portion of the hub shaft than the external thread of the hub shaft.

3. The bicycle hub according to claim 1, wherein
the external thread of the hub shaft extends farther along the hub shaft toward the middle portion of the hub shaft than the first bearing support location of the first shaft bearing.

4. The bicycle hub according to claim 1, wherein
the first shaft bearing includes an inner ring, an outer ring and a roller members between the inner and outer rings with the inner ring being threaded on the external thread of the hub shaft.

5. The bicycle hub according to claim 1, further comprising
a threaded fastener threadedly engaged with the internal thread of the hub shaft.

6. The bicycle hub according to claim 5, wherein
the threaded fastener includes a bolt member, a washer and a retaining member, with the washer being rotatably attached to the bolt member by the retaining member.

7. The bicycle hub according to claim 5, wherein
the internal thread of the hub shaft is formed so that a tip of the bolt member is positioned farther along the hub shaft toward the middle portion of the hub shaft than the first bearing support location of the first shaft bearing.

8. The bicycle hub according to claim 1, further comprising
a freewheel disposed around the hub shaft and operatively coupled to the hub shell to transmit only one directional rotation to the hub shell.

9. The bicycle hub according to claim 8, wherein
the hub shell includes a hub main section and a motive energy carrier non-rotatably coupled to the hub main section,
the freewheel is rotatably supported on an outer circumference of the motive energy carrier, and
the first shaft bearing is at least partially disposed between the motive energy carrier and the hub shaft.

10. The bicycle hub according to claim 1, further comprising
a second shaft bearing threaded on an external thread disposed at least on a second axial end portion of the hub shaft to rotatably support the hub shell on the hub shaft at a second bearing support location, with the internal bore of the hub shaft having an internal thread disposed at the second axial end portion of the hub shaft such that the internal thread of the second axial end portion of the hub shaft extending farther inwardly along the hub shaft in an axial direction toward the middle portion of the hub shaft than the second bearing support location of the second shaft bearing.

11. The bicycle hub according to claim 10, wherein
the first and second axial end portion of the hub shaft are mirror images of each other.

12. The bicycle hub according to claim 10, wherein
the internal threads of the first and second axial end portion of the hub shaft extend farther along the hub shaft toward the middle portion of the hub shaft than the external threads of the first and second axial end portion of the hub shaft, respectively.

13. The bicycle hub according to claim 10, wherein
the external thread of the first and second axial end portion of the hub shaft extend farther along the hub shaft toward the middle portion of the hub shaft than the first and second bearing support locations of the first and second shaft bearings, respectively.

14. The bicycle hub according to claim 10, wherein
each of the first and second shaft bearings includes an inner ring, an outer ring and a roller members between the inner and outer rings with the inner rings being threaded on the external threads of the first and second axial end portion of the hub shaft, respectively.

15. The bicycle hub according to claim 10, further comprising
a first threaded fastener threadedly engaged with the internal thread of the first axial end portion of the hub shaft, and a second threaded fastener threadedly engaged with the internal thread of the second axial end portion of the hub shaft.

16. The bicycle hub according to claim 15, wherein
each of the first and second threaded fasteners includes a bolt member, a washer and a retaining member, with the washer being rotatably attached to the bolt member by the retaining member.

17. The bicycle hub according to claim 15, wherein
the internal threads of the first and second axial end portion of the hub shaft are formed so that tips of the first and second bolt members are positioned farther along the hub shaft toward the middle portion of the hub shaft than the first and second bearing support locations of the and second shaft bearings, respectively.

18. The bicycle hub according to claim 10, further comprising
a freewheel disposed around the hub shaft and operatively coupled to the hub shell to transmit only one directional rotation to the hub shell.

19. The bicycle hub according to claim 18, wherein
the hub shell includes a hub main section and a motive energy carrier non-rotatably coupled to the hub main section,
the freewheel is rotatably supported on an outer circumference of the motive energy carrier, and
the first shaft bearing is at least partially disposed between the motive energy carrier and the hub shaft.
